(19) United States
(12) Patent Application Publication
(10) Pub. No.: US 2024/0002207 A1
(43) Pub. Date: Jan. 4, 2024

(54) FLUID DISPENSER

(71) Applicant: Starbucks Corporation, Seattle, WA (US)

(72) Inventor: Joseph E. Gormley, Mercer Island, WA (US)

(21) Appl. No.: 18/342,555

(22) Filed: Jun. 27, 2023

Related U.S. Application Data
(60) Provisional application No. 63/367,537, filed on Jul. 1, 2022.

(51) Int. Cl. B67D 1/04; B67D 1/12

(52) U.S. Cl. CPC B67D 1/0462; B67D 1/1277

(57) ABSTRACT

A dispensing system can include a container defining an interior and including a first portion and a second portion. The system can include a bag positioned within the interior of the container. The bag can be configured to contain a fluid therein. The system can include an inlet positioned on the container. The inlet can be configured to allow gas into the interior of the container. The system can further include a valve. The valve can be configured to move between an open position and a closed position. The end of the bag can extend through the valve. The end of the bag can define a passage in communication with an opening through which the fluid contained in the bag can be dispensed. In the open position, the valve can be configured to dispense the fluid through the opening.

### CROSS-REFERENCE TO RELATED APPLICATION(S)

This application claims the benefit of U.S. Provisional Application No. 63/367537, filed Jul. 1, 2022, which is hereby incorporated by reference herein in its entirety.

### FIELD

The present disclosure relates to systems and methods for dispensing a fluid, such as, systems and methods for dispensing fluid from a container at room temperature or at temperatures colder than room temperature.

### DESCRIPTION OF THE CERTAIN RELATED ART

Certain beverages are prepared with liquids that need to be frequently dispensed and/or kept at temperatures lower than room temperature. These liquids can include dairy or non-dairy. These liquids can be positioned within a container.

However, the process of dispensing liquids from a container can be time consuming and labor intensive. The process can include moving the container from a storage area to an area for use. The process can also include opening the container, such as unscrewing or uncapping a cap of the container. The process can also include tilting or rotating the container to pour the liquid out of the container, such as with a spout or opening. The process can also include pouring the liquid into a secondary container. The process can also include a dispensing mechanism, such as a pump. Furthermore, these processes can use equipment that requires cleaning in place to maintain sanitary standards.

Additionally, the container may need to be stored at safe temperatures to keep product integrity and prevent spoilage. This can create operation inefficiencies for baristas by requiring opening and closing a refrigerator to remove and return the containers. Traditional refrigeration can also be costly to execute and sometimes access to refrigeration is not possible.

### SUMMARY

The systems, methods and devices of this disclosure each have several innovative aspects, no single one of which is solely responsible for the desirable attributes disclosed herein.

A dispensing system can include a container defining an interior and including a first portion and a second portion. A bag can be positioned within the interior of the container, the bag configured to contain a first fluid therein. An inlet can be positioned on the container, the inlet configured to allow a gas or a second fluid into the interior of the container. A lid can be coupled to the container. The lid can include a valve, wherein the valve is configured to move between an open position and a closed position. An end of the bag can extend through the valve. The end of the bag can define a passage in communication with an opening through which the first fluid contained in the bag can be dispensed. In the open position, the valve can be configured to dispense the first fluid through the opening. In a closed position, the valve can be configured to prevent dispensing of first fluid through the opening. The valve can be configured to open and close at a specific pressure within the container.

In some configurations, the bag can include a flexible material. The end of the bag can include a tip. The tip can be flexible. The inlet can be configured to allow the gas or the second fluid from a source into the interior of the container. The dispensing system can include a controller in communication with the inlet or the source to control a flow of the gas or the second fluid from the source into the interior of the container. The valve can include a pinch valve. The gas or the second fluid can include air. The valve can be biased to the closed position. The container can be hermetically sealed. An amount of the first fluid dispensed can be based on an amount of the gas or the second fluid injected into the interior of the container through the inlet. The dispensing system can include a cylinder. The cylinder can be positioned on a first portion of the container. The cylinder can be configured to receive a predetermined amount of the gas or the second fluid from the interior of the container. The cylinder can be configured to inject the gas or the second fluid into the interior of the container. The dispensing system can further include a controller in communication with the cylinder. The cylinder can be configured to receive the predetermined amount of the gas or the second fluid from the interior of the container or inject the gas or the second fluid into the interior of the container based on instructions from the controller. The valve can be configured to sense a property of a flow rate of the first fluid being dispensed or leaking through the valve. The valve can include a fixed side with a load cell. The valve can include a spring or actuated pinch bar. The dispensing system can further include a controller in communication with the valve, wherein the valve is configured to communicate the flow rate of the first fluid being dispensed or leaking through the valve. The dispensing system can further include a pressure or flow controlled valve along or before the inlet to volumetrically control an amount of the gas or the second fluid supplied to the interior of the container.

In yet another aspect, a dispensing system for dispensing a liquid can include a sealed container. A flexible bag can be positioned within the sealed container. The flexible bag can include an interior configured to contain a liquid therein. An inlet can be positioned on a portion of the sealed container. The inlet can be configured to allow a gas or fluid into the interior of the sealed container. The dispensing system can further include a valve. A portion of the flexible bag can extend through the valve. The valve can be configured to move between an open position and a closed position at a specific pressure within the sealed container. In the open position, the valve can be configured to allow fluid to flow through the portion of the flexible bag that extends through the valve to dispense the liquid.

In some configurations, the dispensing system can include a lid. The lid can include the valve. The valve can be a pinch valve. The portion of the flexible bag that extends through the valve can be a flexible tip.

In one aspect, a method of dispensing a fluid from a dispensing system can include increasing a pressure within a container in which a bag containing a fluid is positioned therein. Increasing the pressure within the container can cause a valve to open to allow the fluid to be dispensed from the bag. The method can include reducing the pressure with the container to cause the valve to close and stop a flow of the fluid from the bag. In some configurations, the valve can be a pinch valve.

In yet another aspect, a dispensing system for dispensing a liquid can include a sealed container. A bag can be positioned within the sealed container. The bag can include an interior containing a liquid therein. The dispensing system can include an inlet to the sealed container. The inlet can be configured to allow a gas or fluid into an interior of the sealed container. The dispensing system can include a valve for controlling a flow of liquid out of the bag. In an open position, the valve can be configured allow the liquid to flow out of the bag to dispense the liquid. The valve can be configured to open and close at a specific pressure within the sealed container.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1A schematically illustrates an embodiment of a dispenser system.

FIG. 1B is a schematic illustration of a pinch valve.

FIG. 2 schematically illustrates another embodiment of a dispenser system.

FIG. 3 schematically illustrates an embodiment of a smart pinch valve for use in a dispenser system.

FIG. 4 schematically illustrates another embodiment of a dispenser system.

### DESCRIPTION

Various dispenser systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein.

For example, many of the embodiments are described in the context of dispensing a liquid from a container at room temperature or at temperatures colder than room temperature. However, certain features and aspects of the disclosure may also have utility in dispensing fluid at temperatures above room temperature or from liquid bases at above room temperature. Many of the embodiments described herein involve dispensing liquid, such as milk or a non-dairy liquid. For instance, in some embodiments, the liquid may be milk, cream, almond milk, soy milk, oat milk, coconut milk, cashew milk, other alternative milks, other plant-based liquids, coffee, tea, juice, or hemp extract. In some embodiments, the liquid may be a flavor, sauce, or syrup such as for ingredient for a beverage or food product. In some embodiments, the dispenser can be used to deliver other ingredients, such as solids or fluids of various viscosities or textures.

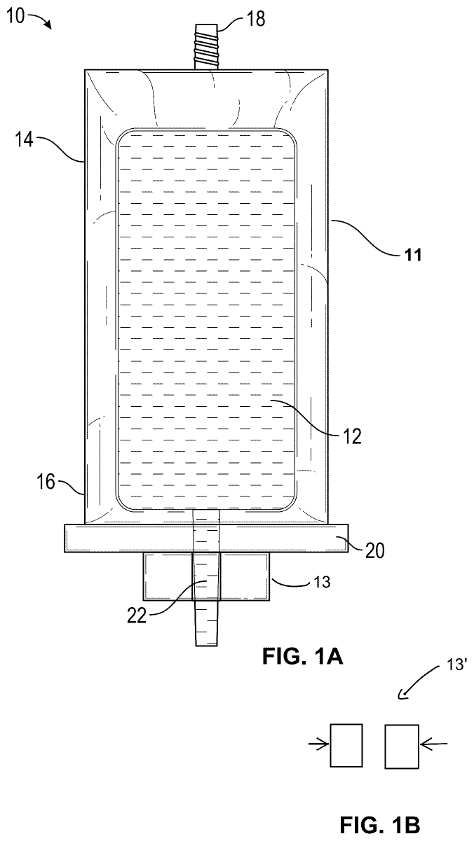

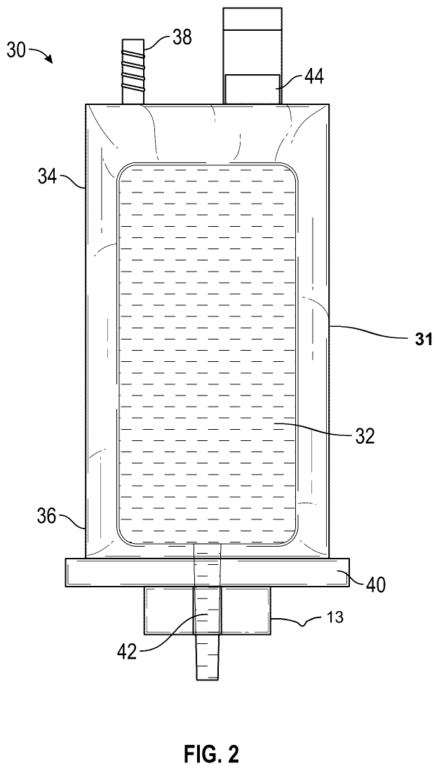

FIG. 1A schematically illustrates an embodiment of a dispenser system 10. The dispenser system 10 can include a bag 12 to hold or store a liquid therein. The bag 12 can be compressed under pressure and can include a combination of flexible or rigid portions, such that the bag or container 12 can be made of a flexible or rigid material of which portions can be compressed to reduce the overall interior volume of the bag 12. By reducing the volume of the bag, fluid within the bag can be “squeezed” out of the bag 12. The bag 12 can be positioned within an interior of an outer member or container 11 which can have a first or top portion 14 and a second or bottom portion 16. In FIG. 1A (and FIG. 2 referenced below), the walls of the container 11 are shown as being transparent such that the bag 12 within the container 11 is visible in the figures and extends through the bottom portion 16. The outer member or container 11 can be hermetically sealed or substantially airtight such that pressure above atmosphere can be obtained within the outer member 11 as described below. As shown in FIG. 1A, the bag 12 can include a flexible end or tip 22 that can extend through a lid 20 which is coupled to the second or bottom portion 16 of the outer member 11. The flexible tip 22 can have a narrower width compared to the remainder of the bag 12. The flexible tip 22 of the bag 12 can define a passage therethrough that can be opened or closed with the lid 20 (as will be described below). The lid 20 can be positioned on the second or bottom portion 16 of the outer member 11. The flexible end or tip 22 of the bag 12 can extend through the lid 20 as shown in FIG. 2. The lid 20 can include an integrated valve or pinch valve 13 which is schematically shown in more detail in FIG. 1B. The pinch valve 13 of the lid 20 can open and close an opening of the flexible tip 22 of the bag 12. In certain embodiments, the pinch valve 13 is configured such that the flexible tip 22 of the bag 12 can extend through the pinch valve 13 in the lid 20. The pinch valve 13 in the lid 20 can then be positioned over the flexible tip 22. In the closed position, the pinch valve 13 can squeeze the opening of the flexible tip 22 closed to prevent dispensing through the opening (or passage through) of the flexible tip 22. In the open position, the pinch valve 13 releases the opening of the flexible tip 22 to permit dispensing through the opening of the flexible tip 22. In this manner, the pinch valve 13 of the lid 20 can open and close the opening of the flexible tip 22. The pinch valve 13 can operate to close and open the bag 12 without contacting the liquid dispensed from the bag 12 even during dispensing of the liquid.

With reference to FIG. 1B, the pinch valve 13′ can be formed in a variety of ways but in certain arrangements can be arranged to reduce the cross-sectional area through which the flexible tip 22 extends. In one embodiment shown in FIG. 1B, the pinch valve 13′ can include two members that can be moved or away from each other. The pinch valve 13′ can be biased to a closed position by springs or other biasing members. The pinching force of the pinch valve 13′ can be adjusted to compensate for different viscosities of fluid. For example, less viscous material may need more pinching force to prevent leaking as compared to more viscous material.

The system can further include an air (or other gas or fluid) inlet 18 positioned on a first or top portion 14 of the container 11. A pressure/flow controlled valve (not illustrated) can be positioned after, along or before the air inlet 18 to volumetrically control the amount of air (or another gas or fluid) supplied to the container 11. The air inlet 18 and the pressure/flow control valve can control both the pressure and air (or other gas or fluid) flow from an air (or other gas or fluid) pump or other air pressure source (e.g., an air or other gas or fluid storage tank) into the interior of the container 11. Air from the air pump (or other source) can be injected into the container 11 through the air inlet 18. The air flow into the container 11 will increase the pressure in the interior of the container 11. As pressure is increased in the interior of the container, the bag 12 can be compressed and liquid contained in the bag 12 can open the pinch valve 13 in the lid 22. When the pinch valve 13 in the lid 22 is opened, liquid can be dispensed from the interior of the bag 12, through the opened pinch valve 13 of the lid 22, and out of the opening in the flexible tip 22 of the bag 12.

The pinch valve 13, 13′ can be configured to open and close at specific pressures. For example, in certain embodiments, the pinch valve can close at a pressure equal to or between 0 bar and 6 bar within the interior of the container 11. As previously described, pressure of the liquid in the interior of the bag 12 can be increased due to the flow of air through the air inlet 18 and into the interior of the container 11. When the pressure is increased, the pinch valve is opened. Additionally, the amount of air injected into the system 10 through the air inlet 18 can determine the amount of fluid dispensed. In certain embodiments, the amount of fluid dispensed from the system can be between or equal to or between from 0.1 oz/sec to 4 oz/sec. As liquid is dispensed through the opening of the tip 22, the pressure in the container 11 will decrease as the volume of the bag 12 decreases, which will in turn force the pinch valve to close and stop liquid from being dispensed. For example, in an embodiment, air flow into the container 11 increases pressure within the container and increases pressure on the bag 12 and the fluid therein forces the pinch valve open. When the amount of fluid dispensed reaches the desired amount, the air flow through the inlet is shut off and the pressure in the bag can be reduced as the volume of the bag 12 within the outer member 11 decreases. With the reduced pressure, the pinch valve can close.

FIG. 2 schematically illustrates another embodiment of a dispenser system 30. The dispenser system 30 can include a bag 32 to hold or store a liquid therein. The bag 32 can be flexible or rigid such that the bag 32 can be made of a flexible or rigid material of which portions can be compressed to reduce the overall interior volume of the bag 32. As with the embodiment of FIG. 1A, the bag 32 can be positioned within an outer member (also referred to as a container) 31 which can have a first or top portion 34 and a second or bottom portion 36. The bag 32 can include a flexible end or tip 42. The flexible tip 42 can have a narrower width compared to the remainder of the bag 32. The flexible tip 42 of the bag 32 can have a passage therethrough that can be opened or closed with a pinch valve that is integrated into a lid 40 as with the embodiment described above. The passage can be in communication with an opening at the end of the tip 42 for dispensing liquid. The outer member 31 can be hermetically sealed or substantially airtight such that pressure above atmosphere can be obtained within the outer member 31 as described below.

The lid 40 can be positioned on a second or bottom portion 36 of the container 31. The lid 20 can be positioned on the flexible end or tip 42 of the bag 32. The lid 40 can include an integrated valve or pinch valve 13 as described above. The pinch valve 13 of the lid 40 can open and close an opening of the flexible tip 42 of the bag 32. The flexible tip 42 of the bag 32 can extend through the pinch valve in the lid 40. The pinch valve in the lid 40 can then be positioned on the flexible tip 42. In the closed position, the pinch valve squeezes the opening of the flexible tip 42 closed to prevent dispensing through the opening of the flexible tip 42. In the open position, the pinch valve releases the opening of the flexible tip 42 to permit dispensing through the opening of the flexible tip 42. In this manner, the pinch valve of the lid 40 can open and close the opening of the flexible tip 42. The pinch valve can operate to close and open the container 32 without contacting the liquid dispensed from the bag 32 even during dispensing of the liquid. The system 30 can also include an cylinder 44 positioned on the first or top portion 34 of the outer member 31.

The system 30 can include an air inlet 38 positioned on a first or top portion 34 of the container 31. The air inlet 38 can allow air to flow from an air source (e.g., a pump or pressurized air supply) to supply air into the interior of the container 31 (as described above with reference to FIG. 1A). Air can be injected into the container 31 through the air inlet 38. The air flow into the container 31 will increase the pressure in the interior of the container 31 which, in turn, can compress the bag 32. As pressure is increased in the interior of the bag 32, the liquid contained in the bag 32 opens the pinch valve in the lid 42. As the pinch valve is opened, liquid can be dispensed from the interior of the bag 32, through the opened pinch valve of the lid 40, and out of the opening in the flexible tip 42 of the bag 32.

The pinch valve can be configured to open and close at specific pressures. As previously described, pressure of the liquid in the interior of the bag 32 can be increased due to the flow of air through the air inlet 38 and into the interior of the container 31. When the pressure is increased, the bag 32 is compressed and the pinch valve is opened. Additionally, the amount of air injected into the system 30 through the air inlet 38 can determine the amount of fluid dispensed. In certain embodiments, 0.1 oz/sec to 4.0 oz/sec of air can be dispensed from the bag 32. As liquid is dispensed through the opening of the flexible tip 42, the pressure in the container 31 will decrease, which will in turn allow the pinch valve to close and stop liquid from being dispensed.

When the air supply (which can be an air pump or air source) supplying air to the inlet stops providing air, the cylinder 44 of the embodiment of FIG. 2 can decrease the pressure in the interior of the container 31 by a set amount of air (or other gas or fluid). For example, the cylinder 44 can act as a pressure release allowing the pressure within the container 31 to decrease (e.g., decrease back to 0 bar). The cylinder 44 can receive a predetermined amount of air (or other gas or fluid) from the interior of the container 31. This can in turn decrease the pressure in the interior of the container 31. The cylinder will reduce the pressure in the container 31 and thus prevent leaks that may occur through the pinch valve. The cylinder 44 can push the predetermined amount of air (or other gas or fluid) back into the interior of the container 31 during the next actuation of the dispenser system 30, which will increase the pressure in the interior of the container 31.

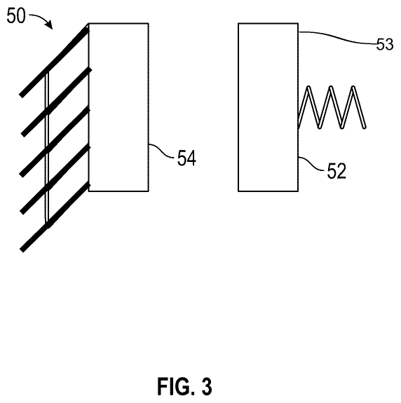

FIG. 3 schematically illustrates an embodiment of a smart pinch valve 50 for use in a dispenser system. For example, the smart pinch valve 50 shown in FIG. 3 may be used in place of the pinch valve in the dispenser system 10 of FIG. 1A or the pinch valve in the dispenser system 30 of FIG. 2. The smart pinch valve 50 can provide force information back to a controller. The force information provided by the smart pinch valve 50 can be used to determine the flow rate of the liquid being dispensed through the dispenser system. For example, in certain embodiments, the greater the force applied to the pinch valve the greater the flow rate through the pinch valve. The determined flow rate can also indicate if there is a leak through the smart pinch valve 50, such as by determining a flow rate when the pinch valve is in a closed position. In the illustrated embodiment, the smart pinch valve 50 can include a fixed side 54 with a load cell and an opposing spring 53 or actuated pinch bar 52. The spring or actuated pinch bar 52 can be configured to close and open the pinch valve as the spring 53 moves the bar 52 towards the fixed side 54 to pinch the flexible tip 42 of the bag 32. The load cell on the fixed side 54 can measure the force of the flow of the liquid through the smart pinch valve 50.

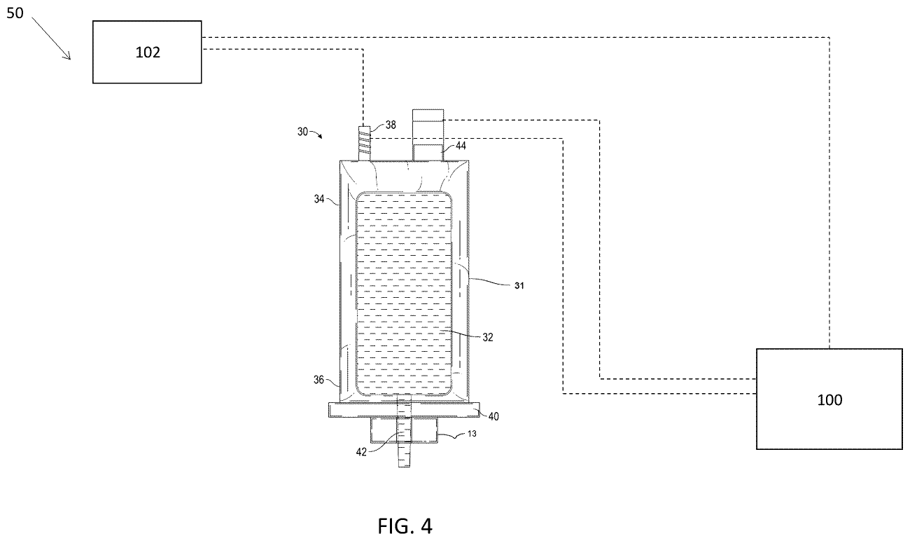

FIG. 4 schematically illustrates another embodiment of a dispenser system. As described above and as shown in FIG. 4, the dispenser system can include an air supply 102, such as an air pump or an air source. The air supply 102 can be in fluid communication with the air inlet 38. The air supply can provide air to the container through the air inlet 48 as described above. As described above and as shown in FIG. 4, the dispenser system can also include a controller 100. The controller 100 can be communicably coupled to the valve 13. The valve 13 can be a smart valve as described above. Similarly, the controller 100 can be communicably coupled to the air inlet 38, the air cylinder 44, and/or the air supply 102. The controller 100 can automatically control the system and cause each of the valve 13, the air inlet 38, the air cylinder 44, and the air supply to execute one or more functions based on instructions from the controller. Each of the valve 13, the air inlet 38, the air cylinder 44 and the air supply can also be configured to relay information to the controller 100. The controller 100 can then modulate the valve 13, air inlet 38, the air cylinder 44 or the air supply 102 to control the pressure within the interior of the container 31 and to cause closing or opening of the valve 13. In this manner, the dispensing process may be substantially automated. For example, the controller 100 can automate the air supply 102 and/or the air inlet 38 such that air can be supplied into the interior of the container 31 to increase the pressure and cause the valve 13 to open. The controller 100 can also automate the air supply 102 and/or the air inlet 38 to stop the flow of air to within the container 31. The controller 100 can automate the air cylinder, such as to cause the air cylinder to receive a predetermined amount of air from the interior of the container 31 or to cause the air cylinder to inject air into the interior of the container 31. Additionally, the controller 100 can further be in communication with and automate the pressure/flow controlled valve positioned after, along or before the air inlet 18 to volumetrically control the amount of supplied to the container 31.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1-21. (canceled)

22. A dispensing system for dispensing a liquid, the dispensing system comprising:
a sealed container;
a flexible bag positioned within the sealed container, the flexible bag comprising an interior configured to contain a liquid therein;
an inlet positioned on a portion of the sealed container, the inlet configured to allow a gas or fluid into the interior of the sealed container; and
a valve,
wherein a portion of the flexible bag extends through the valve and wherein the valve is configured to move between an open position and a closed position at a specific pressure within the sealed container,
wherein, in the open position, the valve is configured to allow fluid to flow through the portion of the flexible bag that extends through the valve to dispense the liquid.

23. The dispensing system of claim 22, further comprising a lid, wherein the lid comprises the valve.

24. The dispensing system of claim 23, wherein the valve is a pinch valve.

25. The dispensing system of claim 22, wherein the portion of the flexible bag that extends through the valve is a flexible tip.

26. A method of dispensing a fluid from a dispensing system comprising:
increasing a pressure within a container in which a bag containing a fluid is positioned therein, wherein increasing the pressure within the container causes a valve to open to allow the fluid to be dispensed from the bag; and
reducing the pressure within the container to cause the valve to close and stop a flow of the fluid from the bag.

27. The method of claim 26, wherein the valve is a pinch valve.

28. A dispensing system for dispensing a liquid, the dispensing system comprising:
a sealed container;
a bag positioned within the sealed container, the bag comprising an interior containing a liquid therein;
an inlet to the sealed container, the inlet configured to allow a gas or fluid into an interior of the sealed container; and
a valve for controlling a flow of liquid out of the bag, wherein, in an open position, the valve is configured allow the liquid to flow out of the bag to dispense the liquid and wherein the valve is configured to open and close at a specific pressure within the sealed container.

29. The dispensing system of claim 28, wherein the bag is flexible, wherein an the inlet is positioned on a portion of the sealed container, wherein an end of the flexible bag extends through the valve, the end of the bag defining a passage in communication with an opening through which the liquid contained in the bag can be dispensed.

30. The dispensing system of claim 28, further comprising a controller in communication with the inlet to control a flow of the gas or the fluid into the interior of the sealed container.

31. The dispensing system of claim 28, the gas or the fluid comprises air.

32. The dispensing system of claim 28, wherein the valve is biased to a closed position.

33. The dispensing system of claim 28, wherein an amount of the fluid dispensed is based on an amount of the gas or the fluid injected into the interior of the sealed container through the inlet.

34. The dispensing system of claim 28, further comprising a cylinder.

35. The dispensing system of claim 34, wherein the cylinder is positioned on a first portion of the sealed container.

36. The dispensing system of claim 34, wherein the cylinder is configured to receive a predetermined amount of the gas or the fluid from the interior of the sealed container.

37. The dispensing system of claim 36, wherein the cylinder is configured to inject the predetermined amount of the gas or the fluid into the interior of the sealed container.

38. The dispensing system of claim 28, wherein the sealed container is hermetically sealed.

39. The method of claim 26, wherein increasing the pressure within the container comprises introducing a gas or a fluid through an inlet of the container and into an interior of the container.

40. The method of claim 39, wherein an amount of the fluid dispensed from the bag is based on an amount of the gas or the fluid introduced into the interior of the container through the inlet.

41. The method of claim 26, wherein reducing the pressure within the container comprises withdrawing a predetermined amount of a gas or a fluid within a cylinder in fluid communication with the container.
